(19) United States
(12) Patent Application Publication
(10) Pub. No.: US 2023/0028792 A1
(43) Pub. Date: Jan. 26, 2023

(54) MACHINE LEARNING ARCHITECTURES FOR CAMERA-BASED DETECTION AND AVOIDANCE ON AIRCRAFTS

(71) Applicant: A^3 by Airbus, LLC, Sunnyvale, CA (US)

(72) Inventors: Cedric Cocaud, Sunnyvale, CA (US); Arne Stoschek, Palo Alto, CA (US); Anne-Claire Lebihan, Toulouse (FR); Alexander Dean Naiman, Toulouse (FR); Stephane Gauthier, Toulouse (FR); Jean-Claude Laperche, Toulouse (FR); Christophe Vlacich, Toulouse (FR)

(73) Assignee: A^3 by Airbus, LLC, Sunnyvale, CA (US)

(21) Appl. No.: 17/788,706

(22) PCT Filed: Dec. 23, 2019
(86) PCT No.: PCT/US19/68384

§ 371 Date: Jun. 23, 2022

(51) Int. Cl. G08G 5/04; G08G 5/00; G06N 20/00

(52) U.S. Cl. CPC G08G 5/045; G08G 5/006; G08G 5/0039; G08G 5/0069; G06N 20/00

(57) ABSTRACT

A monitoring system for an aircraft uses sensors configured to sense objects around the aircraft to generate a recommendation that is ultimately used to determine a possible route that the aircraft can follow to avoid colliding with a sensed object. A first algorithm generates guidance to avoid encounters with sensed airborne aircrafts. A second algorithm generates guidance to avoid encounters with sensed non-aircraft airborne obstacles and ground obstacles. The second algorithm sends inhibiting information to the first algorithm in a feedback loop based on the position of sensed non-aircraft objects. The first algorithm considers this inhibiting information when generating avoidance guidance regarding airborne aircrafts.

### BACKGROUND

Aircraft may encounter a variety of risks during flight, such as collision with other aircraft, equipment, buildings, birds, debris, terrain, and other objects. Self-piloted aircrafts may collect and process sensor data to detect objects in the space around the aircraft that pose a collision risk or may otherwise cause damage or injury to an aircraft or its occupants. The detection, recognition, and/or avoidance of sensed objects may, in some instances, include one or more intelligent (e.g., autonomous) components capable of independently adapting to sensed data and determining a suitable path for the aircraft to follow or a suitable action to perform (e.g. climb, descent, turn) in order to avoid colliding with the objects. Such components may not rely on explicitly programmed instructions, instead applying machine learning techniques to progressively generate modified, improved models and algorithms for perception and decision making.

In order for an aircraft to be certified as meeting airworthiness standards, any software and electronic hardware relating to safety-critical operations (such as collision avoidance) must meet certain standards promulgated by certification authorities, the International Organization for Standardization (ISO), and/or other standards-setting organizations. For example, DO-178 and DO-254, among other standards, may apply to regulate safety-critical hardware and software.

Because software based on machine learning models may not rely on a fixed set of code, several challenges arise with respect to meeting certification standards. Initially, once an aircraft has been certified to meet regulatory standards, the manufacturer of the aircraft may not be able to alter any safety-critical components on which certification was based, including software, without going through a new or supplementary certification process. The process of seeking recertification after each software update, however minor that update may be, may be prohibitively expensive, time-consuming, or otherwise impracticable. Further, the need to include certified safety-critical hardware on the aircraft may limit the hardware choices and configurations available to aircraft manufacturer.

### BRIEF DESCRIPTION OF THE DRAWINGS

The disclosure can be better understood with reference to the following drawings. The elements of the drawings are not necessarily to scale relative to each other, emphasis instead being placed upon clearly illustrating the principles of the disclosure.

FIG. 1 is a diagram of a top-perspective view of an aircraft having an aircraft monitoring system in accordance with some embodiments of the present disclosure.

FIG. 2 is a block diagram of a portion of an aircraft monitoring system in accordance with some embodiments of the present disclosure.

FIG. 3 is a block diagram illustrating an exemplary data flow through a detect and avoid system in accordance with some embodiments of the present disclosure.

FIG. 4A is a block diagram illustrating an exemplary data flow through a sensing system of a detect and avoid system in accordance with some embodiments of the present disclosure.

FIG. 4B is a block diagram illustrating an exemplary data flow through a sensing system of a detect and avoid system in accordance with some embodiments of the present disclosure.

FIG. 5 is a block diagram illustrating an exemplary data flow through an avoidance system of a detect and avoid system in accordance with some embodiments of the present disclosure.

FIG. 6 is a schematic diagram illustrating select components of an avoidance system in accordance with some embodiments of the present disclosure.

In the figures, the use of the same reference numbers in different figures indicates similar or identical items or features. The drawings are not to scale.

### DETAILED DESCRIPTION

The present disclosure generally pertains to computing architectures for aircrafts using autonomous machine learning algorithms for sensing and avoiding external objects. In some embodiments, an aircraft includes an aircraft monitoring system having sensors that are used to sense the presence of objects around the aircraft for collision avoidance, navigation, or other purposes. At least one of the sensors may be configured to sense objects within the sensor's field of view and provide sensor data indicative of the sensed objects. The aircraft includes one or more systems directed to the collection and interpretation of the sensor data to determine whether an object is a collision threat, providing a recommendation or advisory of an action to be taken by the aircraft to avoid collision with the sensed object, and controlling the aircraft to avoid collision if necessary. The detection, recognition, and/or avoidance of sensed objects may, in some instances, include one or more intelligent (e.g., autonomous) components capable of independently adapting to new data and previously-performed computations. Such components may not rely solely on explicitly programmed (e.g., pre-determined) instructions, instead applying machine learning techniques to iteratively train and generate improved models and algorithms for perception and decision making, which models are frozen and deployed on the aircraft after each iteration, until they are updated by the next subsequent update.

A sensing system may take in sensor information and output position and vector and/or classification information regarding a sensed object. A planning and avoidance system may take in the output of the sensing system and may generate an escape path or action that represents a route that the aircraft can follow to safely avoid a collision with the detected object. The escape path or action may, in some embodiments, be passed as an advisory (or guidance) to an aircraft control system that implements the advisory by controlling, as an example, the speed or direction of the aircraft, in order to avoid collision with the sensed object, to navigate the aircraft to a desired location relative to a sensed object, or to control the aircraft for other purposes.

In one embodiment, the architecture for a detect and avoid system is designed so as to comprise at least two avoidance algorithms, each using a machine learning solution to generate respective avoidance recommendations, though other embodiments may not necessarily use machine learning solutions. In an exemplary embodiment, a first algorithm (e.g., an Airborne Collision Avoidance System (ACAS) such as ACAS X, or Daedalus) may be directed to avoiding encounters with airborne aircrafts. A second algorithm responsible for lower priority encounters (e.g. encounters with drones or birds) may be directed to avoiding encounters with other (non-aircraft) airborne obstacles and ground obstacles (e.g., terrain, cranes, etc.). Depending on the type and number of objects being sensed, both algorithms may function to generate guidance, but only one guidance will be sent to the flight management system. If the detected objects are not aircraft, the ground and other airborne obstacles avoidance algorithm will generate the guidance for the flight management system. If the detected objects are aircraft, the airborne aircraft avoidance algorithm will generate the guidance for the flight management system. If detected objects include both aircraft and non-aircraft objects, the ground and other airborne obstacles avoidance algorithm will generate a guidance that will be fed to the airborne aircraft avoidance algorithm instead of the flight management system. This input guidance and the aircraft object detection will be taken in account simultaneously by the airborne aircraft avoidance algorithm to generate a unique blended guidance that is sent to the flight management system. The guidance sent to the flight management system is used to control the aircraft in an appropriate manner. In one embodiment where ground and other airborne objects are not a concern for the environment in which the aircraft is used, only the airborne aircraft avoidance algorithm is used to generate guidance for the flight management system.

In an exemplary embodiment, in addition to guidance, the second algorithm generates one or more inhibits or restrictions that are sent, in a feedback loop, as an input to the first (airborne aircraft) algorithms. The inhibits may include position and/or vector information regarding one or more locations or regions at which ground obstacles or non-aircraft airborne obstacles are located, or should otherwise be avoided, for instance to maintain a certain separation of airspace between the aircraft and the detected objects. The first algorithm may use this inhibit information as a restriction input, so as to factor in the position of non-aircraft objects in its generation of avoidance guidance regarding airborne aircrafts.

In conventional solutions using known standards for avoidance (e.g., ACAS X), avoidance guidance is limited to avoidance of airborne aircraft, and other non-aircraft objects and ground objects are not factored therein. The systems and methods described herein provide a highly-desired improvement to such conventional technology, allowing for the consideration of other sensed obstacles while still giving precedent and priority to aircraft avoidance.

In some embodiments, the detect and avoid system is designed with a sensing system that is certified to a high-level safety standard (as one exemplary embodiment, in accordance with safety classifications used by certification authorities, a Design Assurance Level such as DAL-B, though any standard may be used in other embodiments). The architecture for the sensing system may take in information from two different sensors (e.g., a camera and a radar) each certified to a mid-level safety standard (in the exemplary embodiment, DAL-C). The sensing system may include the output of one of the sensors (a primary sensor) into two dissimilar machine learning algorithms, each functioning in parallel independently from the other, each respectively certified to a lower-level safety standard (e.g., in the exemplary embodiment, DAL-D). The two dissimilar machine learning algorithms are independent in software, each being differently trained upon sensor data. Each machine learning algorithm outputs a respective detection based on the sensor data. A comparison or validation module determines whether the two independent and dissimilar machine learning algorithms output the same detection (or, e.g., within a certain discrepancy or error bound).

In the exemplary embodiment, if the outputs of the two algorithms are confirmed to overlap, the results of one or both of the machine learning algorithms are used by an avoidance system. If the outputs of the two algorithms are not confirmed to overlap (or exceed a preset error bound), the sensed output of the second of the sensors (a fallback sensor) is used by an avoidance system (in some embodiments, after being processed by a third, non-machine learning, algorithm). In the exemplary embodiment, the confirmed overlap of the two machine learning algorithms, each certified to a lower-level safety standard, (together, a dual-algorithm solution) may be certificatable to a mid-level safety standard. Further, the dual-algorithm solution, certified at a mid-level safety standard) taken together with the presence of a fallback sensor certified to a mid-level safety standard, allows the architecture of the sensing system as a whole to be certified to a high-level safety standard.

In conventional solutions, machine learning algorithms cannot, by their nature, be certified to high safety levels under the current certification standards, and therefore, highly-certified sensor systems (e.g., radar) and deterministic legacy software systems must be relied upon, whether as primary or back up systems. In some scenarios, radar and/or deterministic legacy software solutions may be less intelligent, accurate, or capable than modern machine learning solutions, and therefore, the performance of the aircraft's avoidance system may be capped, even as available technology for obstacle avoidance improves. Certification of any improvements is a cumbersome, expensive process that may take several months or years per update.

Contrary to conventional techniques, in the systems and methods described herein, the presence of a plurality of independent dissimilar machine learning solutions, confirmed to produce overlapping, reliable detection guidance, allows for a high-level of safety certification. In addition, the machine learning algorithms may provide a more consistent performance and improvement in accuracy as compared to the information generated by a fallback sensor system.

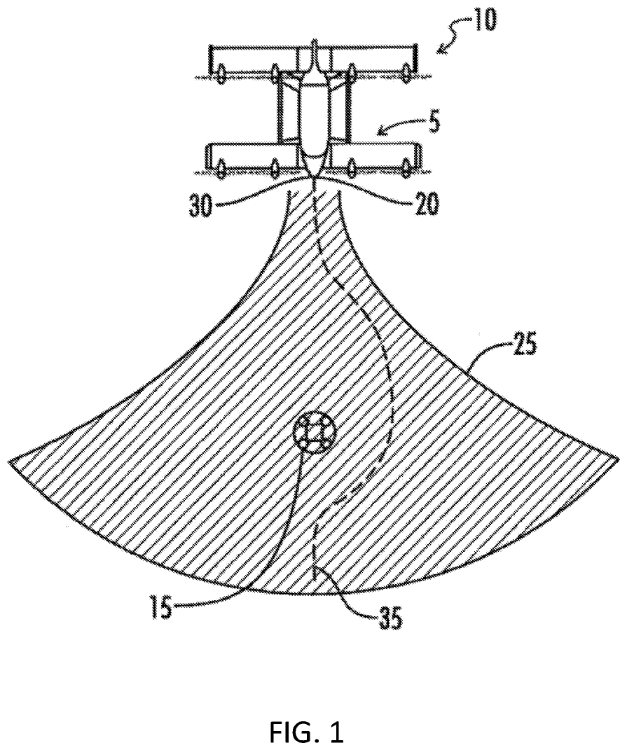

Still further, known sensor technology (e.g., radar) may not be reliable enough to allow for certification of individual sensor hardware at a high-level safety standard. Accordingly, conventional aircraft implementations may use duplicated or redundant sensor technology to reach the required safety levels. The systems and methods described herein minimize redundancy of hardware, allowing for a high level of safety while minimizing the number of physical sensors (e.g., cameras, radar) that must be installed on an aircraft. According, the SWAP (size, weight and power) of the hardware on the aircraft can be reduced, improving aircraft cost, complexity, and performance. FIG. 1 depicts a top-down perspective view of an aircraft 10 having an aircraft monitoring system 5 in accordance with some embodiments of the present disclosure. FIG. 1 depicts the aircraft 10 as an autonomous vertical takeoff and landing (VTOL) aircraft 10, however, the aircraft 10 may be any of various types. The aircraft 10 may be configured for carrying various types of payloads (e.g., passengers, cargo, etc.). In other embodiments, systems having similar functionality may be used with other types of vehicles 10, such as automobiles or watercraft. In the embodiment of FIG. 1, aircraft 10 is configured for self-piloted (e.g., autonomous) flight. As an example, aircraft 10 may fly autonomously, following a predetermined route to its destination under the supervision of a flight controller (not shown in FIG. 1) located on the aircraft 10 or communicably accessible with the aircraft 10. In other embodiments, the aircraft 10 may be configured to operate under remote control, such as by wireless (e.g., radio) communication with a remote pilot. Alternatively or additionally, the aircraft 10 may be a manned or partially manned/partially-autonomous vehicle.

Aircraft 10 has one or more sensors 20 of a first type for monitoring space around the aircraft, and one or more sensors 30 of a second type for sensing the same space and/or additional spaces. Any number of sensors, and any number of types of sensors may comprise the illustrated sensors 20, 30. These sensors may, in various embodiments, be any appropriate optical or non-optical sensor(s) for detecting the presence of objects, such as an electro-optical or infrared (EO/IR) sensor (e.g., a camera), a light detection and ranging (LIDAR) sensor, a radio detection and ranging (radar) sensor, transponders, inertial navigation systems and/or global navigation satellite system (INS/GNSS), or any other sensor type that may be appropriate. For example, a sensor may be configured to receive a broadcast signal (e.g., through Automatic Dependent Surveillance-Broadcast (ADS-B) technology) from an object indicating the object's flight path.

For ease of illustration, FIG. 1 only depicts sensors 20, 30 at the front of the aircraft 10, however, in a preferred embodiment, sensors 20, 30 may be located in various positions on the aircraft 10 and may have a full or partial field of view around the aircraft in all directions. The aircraft monitoring system 5 of FIG. 1 is configured to use the sensors 20, 30 to detect an object 15 that is within a certain vicinity of the aircraft 10, such as near a flight path of the aircraft 10. Such sensor data may then be processed to determine whether the object 15 presents a collision threat to the vehicle 10. In this regard, aircraft monitoring system 5 may be configured to determine information about the aircraft 10 and its route. The aircraft monitoring system 5 may, for example, determine a safe escape path for the aircraft 10 to follow that will avoid a collision with the object 15.

The object 15 may be any of various types that aircraft 10 may encounter during flight, for example, another aircraft (e.g., airplane or helicopter), a drone, a bird, debris, or terrain, or any other of various types of objects that may damage the aircraft 10 or impact its flight, if the aircraft 10 and the object 15 were to collide. The object 15 is depicted in FIG. 1 as a single object that has a specific size and shape, but it will be understood that object 15 may represent one or several objects that may take any of a variety of shapes or sizes and may have various characteristics (e.g., stationary or mobile, cooperative or uncooperative). In some instances, the object 15 may be intelligent, reactive, and/or highly maneuverable, such as another manned or unmanned airborne aircraft in motion.

FIG. 1 further illustrates an exemplary process of how a detected object 15 may be avoided. The aircraft monitoring system 5 may use information about the aircraft 10, such as the current operating conditions of the aircraft (e.g., airspeed, altitude, orientation (e.g., pitch, roll, or yaw), throttle settings, available battery power, known system failures, etc.), capabilities (e.g., maneuverability) of the aircraft under the current operating conditions, weather, restrictions on airspace, etc., to generate one or more paths that the aircraft is capable of flying under its current operating conditions. This may, in some embodiments, take the form of generation of an escape envelope 25 that defines the boundaries of a region representing a possible range of paths that aircraft 10 may safely follow. The escape envelope 25 (shown as a “funnel” shape) may be understood as the envelope or universe of possible avoidance maneuvers. This escape envelope may take any shape but generally widens at points further from the aircraft 10, indicative of the fact that the aircraft 10 is capable of turning farther from its present path as it travels. The aircraft monitoring system 5 may then select an escape path 35 within the escape envelope 25 for the aircraft 10 to follow in order to avoid the detected object 15.

In identifying an escape path 35, the aircraft monitoring system 5 may use information from sensors 20, 30 about the sensed object 15, such as its location, velocity, and/or probable classification (e.g., that the object is a bird, aircraft, debris, building, etc.). Sensors 20, 30 are capable of detecting objects anywhere within their field of view. As mentioned above, the sensors have a full or partial field of view all around the aircraft (not specifically shown) in all directions; the field of view is not limited to the escape envelope 25 illustrated in FIG. 1. Escape path 35 may also be defined such that the aircraft will return to the approximate heading that the aircraft was following before performing evasive maneuvers. As the aircraft 10 follows the escape path 35 and changes position, additional sensed information may be received through sensors 20, 30, and alternate escape paths, or changes to escape path 35, may be determined and/or followed based on an assessment of the additionally sensed information.

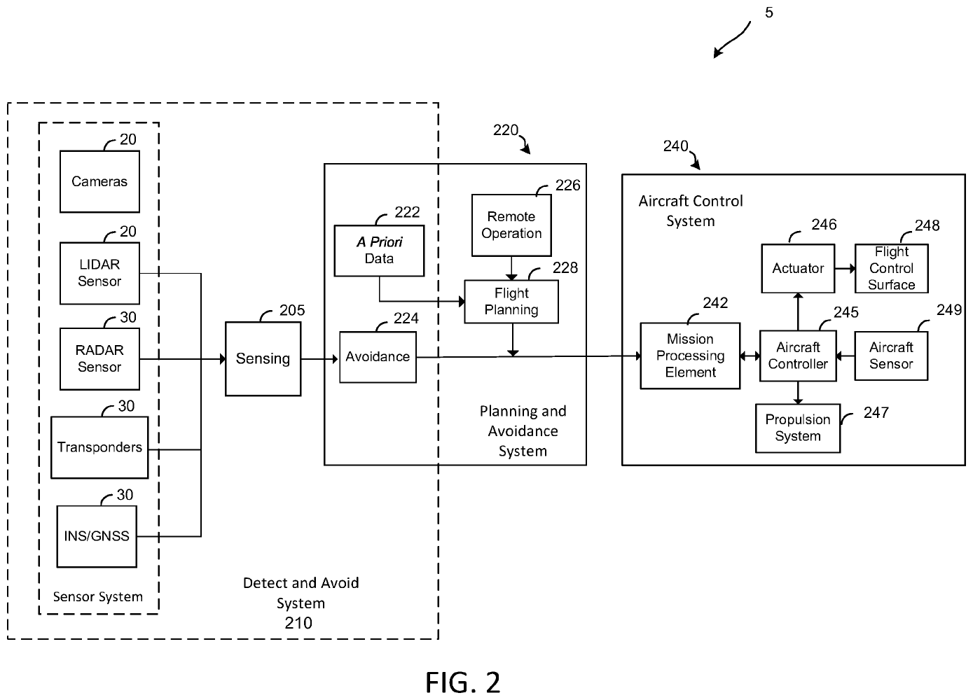

FIG. 2 depicts select components of an exemplary aircraft monitoring system 5 that may be installed on an aircraft, including one or more sensors 20, one or more sensors 30, a sensing system 205, a planning and avoidance system 220 (that may include, e.g., an avoidance system 224 and a flight planning system 228, among other components), and an aircraft control system 240 that may include, e.g., a mission processing element 242, an aircraft controller 245, a propulsion system 247, and one or more actuators 246, among other components. Components of the aircraft monitoring system 5 may reside on the vehicle 10 or may be housed in a different location while being communicably accessible to other components, or a combination thereof. Components of the system 5 may communicate with each other through wired (e.g., conductive) and/or wireless (e.g., wireless network or short-range wireless protocol, such as Bluetooth) communication, however alternate implementations may be used in different embodiments.

The components shown in FIG. 2 are merely illustrative, and the aircraft monitoring system 5 may comprise various components not depicted for achieving the functionality described herein and/or for generally performing collision threat-sensing operations and vehicle control. Similarly, although particular functionality may be ascribed to various components of the aircraft monitoring system 5 as discussed herein, it will be understood that in other alternate embodiments, such functionalities may be performed by different components, or by one or more components.

A combination of some components from the sensors 20, 30, the sensing system 205, and the planning and avoidance system 220 function together as a “detect and avoid” element 210. The detect and avoid element 210 may perform processing of sensor data (as well as other data, such as flight planning data (e.g., terrain and weather information, among other things) and/or data received from aircraft control system 240 regarding an escape envelope) to generate an avoidance recommendation (or advisory) for an action to be taken by the aircraft controller 245. Data in support of this avoidance recommendation may be sent from the sensing system 205 to an avoidance element 224 (of planning and avoidance system 220), which applies one or more avoidance algorithms thereto to generate an optimized escape path. In some embodiments, the avoidance algorithm may be deterministic or probabilistic in nature. The avoidance element 224 may, in some embodiments, employ a machine learning algorithm to classify and/or detect the location of an object 15 in order to better assess its possible flight performance, such as speed and maneuverability, and threat risk. In this regard, the system 5 may store object data that is indicative of various types of objects, such as birds or other aircraft that might be encountered by the aircraft 10 during flight, and may identify and/or classify sensed objects. It is possible to identify not just categories of objects (e.g., bird, drone, airplane, helicopter, etc.) but also specific object types within a category.

The avoidance algorithm(s) may, in some embodiments, also consider information from flight planning system 228. Such information may include, for example, a priori data 222, e.g., terrain information about the placement of buildings or other known static features, information about weather, airspace information, including known flight paths of other aircrafts (for example, other aircrafts in a fleet), and/or other relevant predetermined (or pre-discoverable) information. Such information may also include remote operation data 226, which may include information received from remote systems (e.g., air traffic control, operator information, etc.).

The planning and avoidance system 220 may provide its generated path information and/or other signals to the mission processing element 242 of aircraft control system 240. As one example of many, the planning and avoidance system may generate an escape action such as “climb at 500 ft/min and maintain regime until an advisory alert is turned off,” though any appropriate type of escape path or action may be used. The escape path or action may, in some embodiments, be passed as an advisory to an aircraft control system that implements the advisory by controlling, as an example, the speed or direction of the aircraft, in order to avoid collision with the sensed object, to navigate the aircraft to a desired location relative to a sensed object, or to control the aircraft for other purposes. In some embodiments, the aircraft controller 245 may perform suitable control operations of the aircraft 10 by providing signals or otherwise controlling a plurality of actuators 246 that may be respectively coupled to one or more flight control surfaces 248, such as rudders, ailerons, elevators, flaps, spoilers, brakes, or other types of aerodynamic devices typically used to control an aircraft. Although a single actuator 246 and a single flight control surface 248 are depicted in FIG. 2 for simplicity of illustration, any practical number of actuators 246 and flight control surfaces 248 may be implemented to achieve flight operations of aircraft 10. The propulsion system 247 may comprise various components, such as engines and propellers, for providing propulsion or thrust to the aircraft 10. One or more aircraft sensors 249 may monitor operation and performance of various components of the aircraft 10 and may send feedback indicative of such operation and performance to the aircraft controller 245. In response to the information provided by the aircraft sensor 249 about performance of the systems of the aircraft 10, the aircraft controller 245 may control the aircraft 10 to perform flight operations.

It will be understood that the aircraft controller 245 is a reactive system, taking in the recommendation of detect and avoid system 210 and reacting thereto. In response to receiving the recommendation, the mission processing element 242 may be configured to provide a signal to aircraft controller 245 to take an action in response to the threat, such as providing a warning to a user (e.g., a pilot or passenger) or controlling the aircraft control system 240 (e.g., actuators 246 and the propulsion system 247) to change the velocity (speed and/or direction) of the aircraft 10. As an example, the aircraft controller 245 may control the velocity of the aircraft 10 in an effort to follow an escape path 35, thereby avoiding a sensed object 15. Alternatively, the aircraft controller 245 may navigate to a desired destination or other location based on the position, known or anticipated direction, and/or speed of the sensed object 15.

The various components of the aircraft monitoring system 5 may be implemented in hardware or a combination of hardware and software/firmware. As an example, the aircraft monitoring system 5 may comprise one or more application-specific integrated circuits (ASICs), field-programmable gate arrays (FPGAs), and/or microprocessors programmed with software or firmware, or other types of circuits for performing the described functionalities. Systems 210, 220, and 240 may in some embodiments be implemented on discrete computing hardware and/or software, or in alternate embodiments, some components may be implemented with the same computing hardware or may share processors or other resources. Any appropriate configuration may be used, for example based on considerations such as weight and power consumption, communication latency, processing and/or computational limitation, or varying safety requirements for different systems.

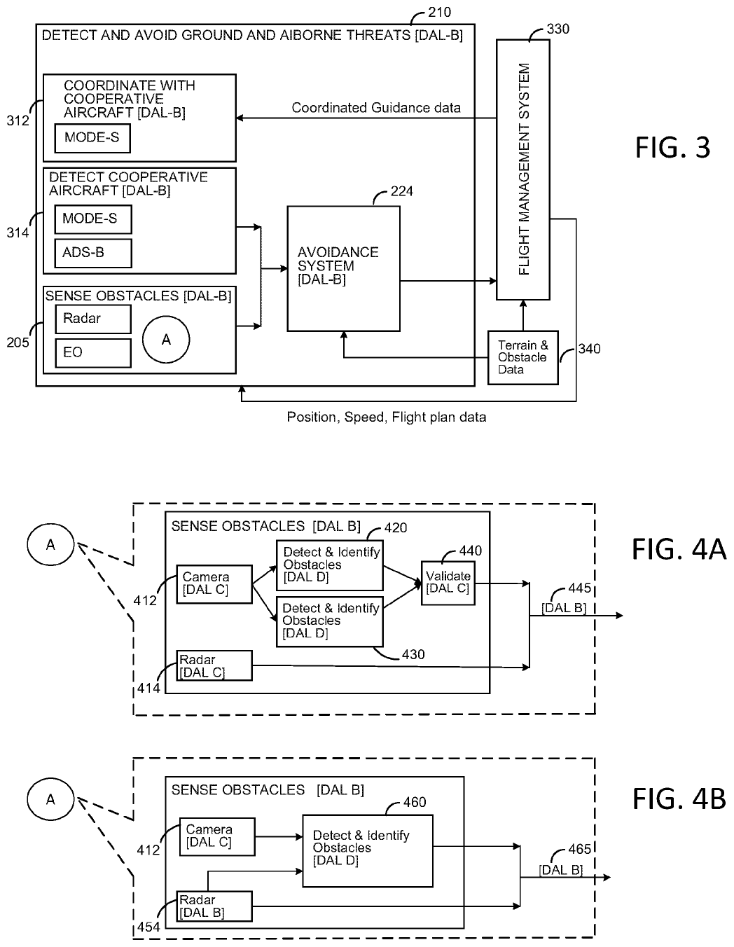

FIG. 3 illustrates an exemplary data flow through the sensing system 205 and avoidance system 224 of detect and avoid system 210. In the illustrated embodiment, avoidance system 224 may receive information from two primary sources. A module 314 collects information from intelligent aircrafts and/or vehicles or objects (also referred to as “cooperative” aircraft) that are capable of communication with the aircraft 10. Module 314 may include, for example, sensor(s) configured to receive a broadcast signal from an object indicating the object's flight path, for example through Automatic Dependent Surveillance-Broadcast (ADS-B), Mode S (a secondary surveillance radar process that allows selective interrogation of aircraft), Mode S EHS (Enhanced Surveillance), or any other protocol or system capable of receiving at least position information from another aircraft or from an air traffic management system. Module 314 may receive beacon information from these cooperative aircraft and may use such information to generate or output position and vector information regarding cooperative aircraft in the airspace around aircraft 10.

The second source of data provided to avoidance system 224 is the sensing system 205 which may take in the input from one or more sensors and output position and vector regarding one or more objects or obstacles sensed therein. In the illustrated embodiment, sensing system 205 is shown to collect information from an electro-optical (EO) sensor (e.g., a camera) and a radio detection and ranging (radar) sensor, however, in other embodiments, any sensor data may be used, such as data from one or more of an electro-optical or infrared (EO/IR) sensor, a light detection and ranging (LIDAR) sensor, a radar sensor, other sensor types, or any combination thereof. Non-cooperative aircraft (e.g., drones, certain other aircraft, and other airborne objects) cannot broadcast their own position information, and accordingly, detect and avoid system 210 uses this sensor system to detect such traffic, as well as other obstacles on the ground or in the air. In some embodiments, sensors such as transponders, inertial navigation systems and/or global navigation satellite system (INS/GNSS) may be used to collect information that is variously used by detect and avoid system 210, for example to derive the absolute position of a sensed object with regard to the aircraft 10. As the sensed data is safety critical, the sensors providing such data may be required to meet one or more safety standards. In one embodiment, the safety standards may be based on or derived from classifications used by the certification authorities, e.g., the Design Assurance Levels (DALs) “A” through “E”, each level being respectively less stringent. Other standards may be used in other embodiments, whether promulgated by certification authorities, the International Organization for Standardization (ISO), and/or other standards-setting organizations.

The generated outputs of module 314 and system 205 are typically position and/or vector data regarding objects or sensed obstacles in the airspace around aircraft 10. In embodiments, these outputs may also variously include classification data regarding the sensed objects and obstacles, identifying categories of objects (e.g., bird, drone, airplane, helicopter, tree, mountain, crane/equipment, unknown, etc.) and/or specific object types within a category (e.g., aircraft type or class) or other characteristics of the object (e.g., payload, nature of movement (e.g., known or erratic), etc.). The outputs are sent to the avoidance system 224 which may apply one or more algorithms to such data to generate an avoidance recommendation or advisory for how to avoid the sensed object, if necessary. The avoidance system may also rely upon known terrain and/or obstacle data (stored, e.g., in database 340) that may not necessarily be sensed by the system 205. The recommendation or advisory is passed to flight management system 330 (which may, in some embodiments, take in information from the terrain and obstacle data 340), which system functions to control the aircraft to avoid the sensed obstacles (if appropriate). The flight management system 330 may transmit information about the aircraft 10's position, speed and flight plan back to detect and avoid system 210. The flight management system 330 may also generate coordinate guidance data, which data is sent to the module 312 to send to any cooperative (e.g., intelligent) aircraft within the relevant airspace.

FIGS. 4A and 4B illustrates exemplary data flows through the sensing system 205 of detect and avoid system 210. FIG. 4A depicts an architecture of the system 205 in accordance with an exemplary embodiment. Two image sensors are illustrated, a camera 412 and a radar 414, each certified to a DAL-C standard. The camera 412 may be referred to herein as a “primary” sensor, and the radar 414 may be referred to herein as the “secondary” or “fallback sensor. Two dissimilar machine learning algorithms 420 and 430, each certified to a DAL-D standard, take in image data from camera 412. The output of each algorithm 420, 430 (position and/or vector data, and in some embodiments classification data) is sent to a validation module 440, which determines whether the outputs of the algorithms 420, 430 overlap. That is, validation module 440 determines whether the outputs of the algorithms are the same, within a given percentage or error bound, meaning that both algorithms detect or recognize the same object(s) in the image data. The results of machine learning algorithm 420 are confirmed by the results of machine learning algorithm 430, and vice versa, increasing the assurance that such results are accurate. In some embodiments, the detections of the two algorithms may be determined to overlap as long as they agree on the position data of sensed objects, even if they do not agree on the classification of those objects.

Because the results of the machine learning algorithms are self-validating, the validation module 440, taking in the outputs of two independent and dissimilar modules certified to a DAL-D standard (dual-algorithm output), can together be certified to a DAL-C standard. The validation module 440, and the output of the radar 414, can be considered together by one or more other components of the sensing system 205 or the avoidance system 224, and that aggregated result 465 may be certified to a DAL-B standard. It may be generally understood from the architecture of FIG. 4A that the output of camera 412 and the output of radar 414 are used discretely and are not compared to each other. The machine learning algorithms 420, 430 are therefore not bound to the secondary, fallback system provided by radar 414, and the dual-algorithm solution can operate by itself to generate DAL-C output. The machine learning algorithms, certified to a DAL-D standard, may be more easily individually recertified if updated, as the time and expense of such recertification may in some embodiments be less than recertification of a DAL-B component.

It may be generally understood of course that any number of sensors and other components and/or any relevant safety standard(s) may be used in other embodiments. In the discussion of FIGS. 4A and 4B, DAL-B may be referred to as a “high-level” safety standard, DAL-C may be referred to as a “mid-level” safety standard, and DAL-D may be referred to as a “low-level” safety standard, however such terms are simply used for ease of explanation and are not intended to describe, categorize, or otherwise limit the actual safety standards, the levels of certification required, or any limitations on the certificatability, safety, reliable, or functionality of the components described herein.

The exemplary machine learning algorithms 420 and 430 are dissimilar to each other. As illustrated, the algorithms function in parallel, taking in the same image data, however, each are independent in software and are trained differently upon the sensor data, using different training datasets. In some embodiments, the algorithms 420 and 430 may additionally be independent in hardware, such that each uses a respective processor (or set of processors). In other embodiments, the algorithms 420, 430 may share hardware but be arranged to be logically independent from each other. In some alternative embodiments, the code of algorithms 420, 430 may include position-independent code, or may be stored in different sections of a memory. Accordingly, in the exemplary embodiment, the respective datasets, neural network architecture, and/or the testing and validation of the results may differ between the algorithms 420 and 430.

In some embodiments, rather than applying both algorithms to exactly the same images, camera 412 may output multiple frames in a short period of time (e.g., two frames per second), and the frames may be alternatingly processed by either of algorithms 420 and 430. As a result, although the two algorithms function in parallel, the throughput and real-time performance is not diminished.

In the exemplary embodiment, if the outputs of the two algorithms are confirmed to overlap, the result of one or both of the machine learning algorithms are used by an avoidance system. If the outputs of the two algorithms are not confirmed to overlap, the sensed output of the second sensor(s) (a fallback sensor) is used by the avoidance system 224. In some embodiments, the fallback sensor data may be first processed by a one or more (non-machine learning) algorithms.

In the exemplary embodiment, the confirmed overlap of the two machine learning algorithms each certified to a lower-level safety standard (together, a dual-algorithm solution) increases the assurance of the machine learning result beyond what an individual algorithm could be certifiable on under the existing frameworks, due to the nature of how a machine learning algorithm operates.

FIG. 4B depicts another embodiment of sensing system 205 that relies upon a radar 454, certified to the DAL-B standard, that operates as a fallback sensor. In alternate embodiments, rather than a DAL-B sensor 454, two different types of DAL-C sensors may be used. The output of camera 412 and radar 454 are fused together and processed by sensing algorithm(s) 460 to generate position and/or vector data regarding a complete set of detections for the airspace around aircraft 10. Sensing algorithm(s) 460 may include a machine learning algorithm. In some embodiments, the results of algorithm 460 are bound to the performance of the radar 454, which is certified to a high-level safety standard, such that any detection outside the error bound of the radar 454 is classified as a false detection and ignored. Accordingly, if the radar 454 does not detect an object or obstacle, no object or obstacle is recognized, regardless of whether an object is detected by the lower-certified camera 412 and algorithm 460. In some embodiments, each of the detections from the camera 412 and the radar 454 have an uncertainly value associated therewith, such as an uncertainty percentage value or position error. The algorithm(s) 460 and the avoidance system 224 take the uncertainty from both sensor data tracks into consideration, outputting guidance for avoidance to the flight management system 330.

In the embodiment of FIG. 4B, the radar 454 functions as a fallback system to ensure that high level (e.g., DAL-B) safety standards are met. The accuracy and performance of the sensing system 205 are therefore checked, and in some cases limited, by the capabilities of radar 454 Because of this, in some circumstances, the embodiment of FIG. 4A may be more favorably implemented, such as where the machine learning algorithms may deliver more consistent and accurate detection results than the radar.

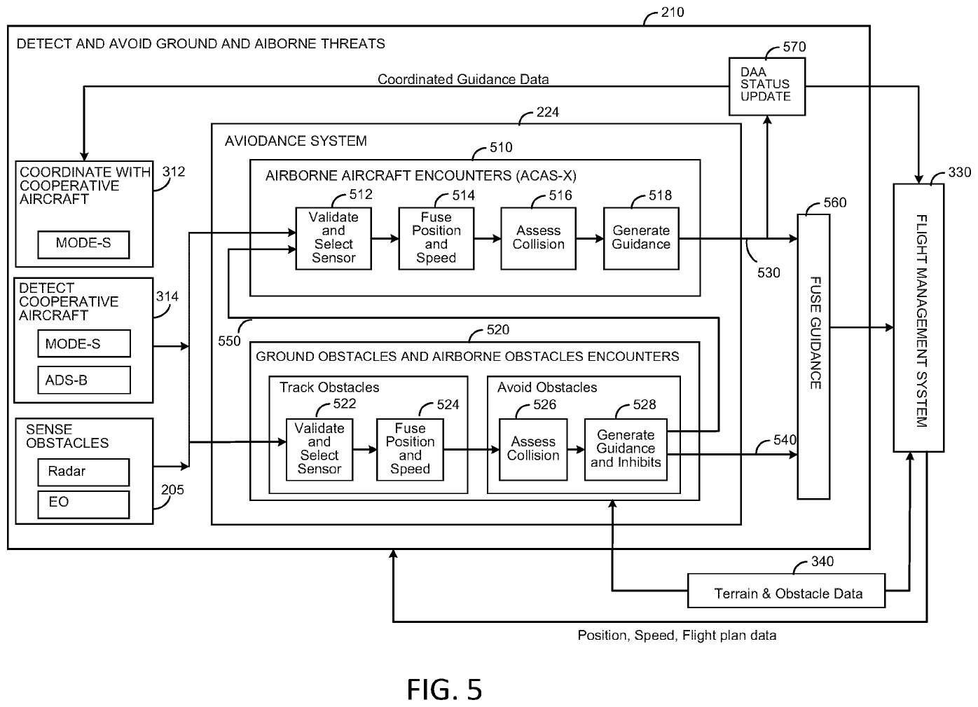

FIG. 5 illustrates an exemplary data flow through the avoidance system 224 of detect and avoid system 210. Avoidance system 224 comprises at least two avoidance algorithms (in various embodiments, machine learning or non-machine learning solutions), airborne aircraft encounters logic 510 and ground obstacles and airborne obstacles encounters logic 520, each generating respective avoidance recommendations 530 and 540. Any generated avoidance recommendations or guidances 530, 540 are considered by a fuse guidance module 560. Fuse guidance module 560 selects which of recommendations 530 and 540 to use, and outputs the selected recommendation to flight management system 330 that controls the aircraft 10 accordingly to avoid collision. The flight management system 330 may transmit information about the aircraft 10's position, speed and flight plan back to detect and avoid system 210. The flight management system 330 may also transmit such data to a detect and avoid (DAA) status update module 570, which generates coordinate guidance data, and transmits the same to the module 312 to send to any cooperative (e.g., intelligent) aircraft within the relevant airspace.

In an exemplary embodiment, airborne aircraft encounters logic 510 may be any Airborne Collision Avoidance System (ACAS), (e.g. ACAS X), or any other safety rated algorithm(s) directed to avoiding encounters with airborne aircrafts. The airborne aircraft encounters logic 510 is limited to the detection of aircraft, e.g., planes, helicopters, and the like. A detected aircraft may be likely to be carrying passengers, and therefore, the avoidance of collision between aircraft 10 and other detected aircraft is of paramount importance. Collision with aircraft carrying other types of cargo or payload is similarly important. However, many other obstacles may exist in the airspace around aircraft 10, including airborne objects such as birds or drones, and ground obstacles within the aircraft 10's flight plan. This may include for instance, trees, equipment (e.g., cranes), mountains or terrains, or other objects, whether at a high altitude, or, in circumstances involving takeoff and landing, lower altitudes. Avoidance system 224 takes such risks into consideration through the application of ground obstacles and airborne obstacles encounters logic 520, containing algorithm(s) directed to avoiding encounters with other non-aircraft airborne obstacles and ground obstacles.

In an exemplary embodiment, sensor system 205 and module 314 for detecting cooperative aircraft may transmit position and/or vector information to the system 224 indicating one or more detected objects. In some embodiments, the transmitted data may also include classification information that may be used to categorize the sensed objects as aircraft or non-aircraft, and/or into other more granular categories. In the case that an object is sensed, both algorithms 510 and 520 may function to generate guidance for a flight management system. In an exemplary embodiment, if the fuse guidance module 560 receives an output 530 from airborne aircraft encounters logic 510, fuse guidance module 560 selects that output for transmission to the flight management system 330 and ignores or discards any output 540 from ground obstacles and airborne obstacles encounters logic 520, as output 530 represents guidance regarding a detected aircraft, a higher priority target. In cases where the ground obstacles and airborne obstacles encounters logic 520, and the airborne aircraft encounters logic 510 are both generating a guidance in response to sensed objects of the category they are respectively responsible for, the guidance of the ground obstacles and airborne obstacles encounters logic 520 is sent to the airborne aircraft encounters logic 510 (to be factored into a combined or blended guidance output), and is discarded by the fuse guidance module 560 such that only the blended guidance 530 provided by the airborne aircraft encounters logic 510 is transmitted to the flight management system 330. If fuse guidance module 560 does not receive an output 530 from airborne aircraft encounters logic 510, and only receives an output 540 from ground obstacles and airborne obstacles encounters logic 520, then fuse guidance module 560 uses the output 540, which output represents a non-aircraft detection for transmission to the flight management system 330.

Airborne aircraft encounters logic 510 includes, in an exemplary embodiment, four modules 512-518, however other embodiments may include any number of modules and/or and configuration of functionalities therebetween. FIG. 5 illustrates a module 512 for validation and/or selection of data received from the sensor system (e.g., selecting between the output of a camera and/or radar) and/or received data regarding detections of cooperative aircrafts from module 314. Logic 510 may also include a module 514 to fuse and/or process position, speed, direction, and/or other kinematic data received from sensor system 205 and module 314, a module 516 to assess whether a collision will occur between aircraft 10 and/or one or more detected aircrafts, and a module 518 to generate guidance to control the aircraft 10 to avoid collision with any detected aircrafts, if appropriate.

Ground obstacles and airborne obstacles encounters logic 520 includes, in an exemplary embodiment, four modules 522-258, however other embodiments may include any number of modules and/or and configuration of functionalities therebetween. FIG. 5 illustrates a module 522 for validation and/or selection of data received from the sensor system and a module 524 to fuse and/or process position, speed, direction, and/or other kinematic data received from sensor system 205. Modules 522 and 524 can be understood to both relate to the tracking of obstacles within the airspace around the aircraft. Logic 520 may also include a module 526 to assess whether a collision will occur between aircraft 10 and/or one or more detected aircrafts, and a module 528 to generate guidance to control the aircraft 10 to avoid collision with any detected aircrafts, if appropriate. Modules 526 and 528 can be understood to both relate to the avoidance of obstacles within the airspace around the aircraft.

In one embodiment, if the object is known (or is determined by algorithms 510 and/or 520) not to be an aircraft, the airborne aircraft avoidance logic 510 does not completely process such data, and therefore, does not generate a unique guidance. The ground obstacles and airborne obstacles encounters logic 520 does generate a unique guidance instead. Fuse guidance 560 therefore receives only one input, output 540 from ground obstacles and airborne obstacles encounters logic 520, and uses that output to transmit guidance to the flight management system 330.

Even in a case that an aircraft is detected, the avoidance system architecture allows consideration of ground or other airborne objects through the use of a feedback loop. While the output 540 of the ground obstacles and airborne obstacles encounters logic 520 will be discarded by fuse guidance module 560, module 528 generates guidance in a form readily interpretable by the flight management system as well as in the form of inhibits or restrictions 550 that are sent, in a feedback loop, as an input to the module 512 of airborne aircraft encounters logic 510. The inhibits 550 may set out position and/or vector information (and in some embodiment classification information) regarding one or more locations or regions at which ground obstacles or non-aircraft airborne obstacles are located. In some embodiments, the inhibits 550 may include a space larger or broader than the particular locations of the detected objects, so as to provide sufficient buffer to ensure safety of the vehicle 10 and/or to control the speed and angle of movement to avoid excessive force or trauma to the passengers inside vehicle 10. Airborne aircraft encounters logic 510 may use this information as a restriction input, so as to factor in the position of non-aircraft objects in its generation of avoidance guidance regarding airborne aircrafts. That is, module 518 may, in generating guidance for how to control aircraft 10 to avoid collision with an aircraft, limit the guidance to further avoid positions of areas of airspace specified by the inhibits 550, as such areas have been determined by logic 520 to likely contain other obstacles.

The feedback loop with data 550 is sent by ground obstacles and airborne obstacles encounters logic 520 each time the logic 520 makes a detection of the proper category, such that, in an exemplary embodiment, module 528 outputs both guidance 540 and inhibits 550 in parallel, regardless of whether guidance 540 will be selected by fuse guidance module 560. By these means, the detections by the ground obstacles and airborne obstacles encounters logic 520 can be considered by the logic 510, which is, in some embodiments, in line with a proven software standard (e.g., ACAS X).

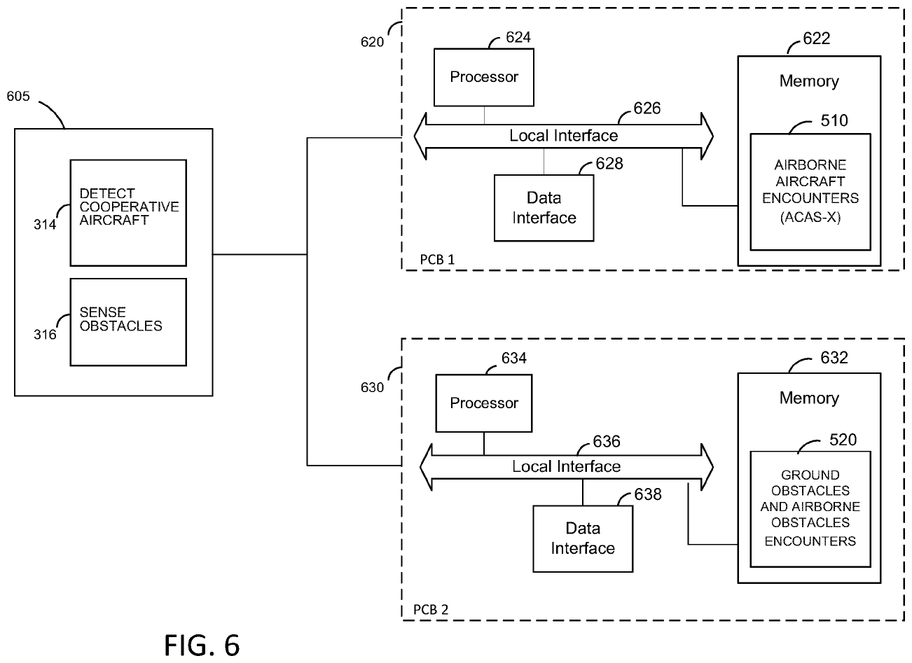

FIG. 6 illustrates an example schematic diagram of certain components of an exemplary avoidance system 224. The avoidance system 224 may be implemented in hardware or a combination of hardware and software/firmware. In one embodiment, the logic for tracking and avoiding airborne aircraft encounters 510 and the logic for tracking and avoiding ground obstacles and airborne obstacle encounters 520 may be arranged so as to be on different processing cores from each other. As an example, the aircraft logic 510 and the ground and airborne obstacles logic 520 may each include one or more application-specific integrated circuits (ASICs), field-programmable gate arrays (FPGAs), and/or microprocessors programmed with software or firmware, or other types of circuits for performing the described functionalities. In one embodiment, the aircraft logic 510 and the ground and airborne obstacles logic 520 are implemented on two different processing units (or computers). In the exemplary embodiment of FIG. 6, for example, this might take the form of implementation on two different printed circuit boards, PCB 1 and 2, respectively. In alternate embodiments, the logics may function on the same board, but on different processing cores. By this setup, a physical (e.g., environmental) upset to the PCB (or, alternatively, processing units) of logic 520 would not impact the functioning of the logic 510, and the avoidance logic would continue to function to avoid detected aircraft. What is more, because the aircraft logic 510 and the ground and airborne obstacles logic 520 work in parallel, even in the instance of a failure, the avoidance system 224 would still function satisfactorily. In an alternate embodiment, the aircraft logic 510 and the ground and airborne obstacles logic 520 may be on the same PCB, however, they may be implemented so as to be logically decoupled.

As shown by FIG. 6, the PCT 620 containing aircraft logic 510 and the PCT 630 containing ground and airborne obstacles logic 520 may respectively include one or more processors 624 and 634, one or more of memory 622 and 632, one or more of data interfaces 628 and 638 (e.g., ports or pins), and at least one local interface 626 and 636. The processors 624 and 634 may include any of a central processing unit (CPU), a digital signal processor (DSP), a graphics processing unit (GPU), an FPGA, an ASIC, or other types of circuits or processing hardware, or any combination thereof. Further, the processor 360 may include any number of processing units to provide faster processing speeds and/or redundancy. The processors 624 and 634 may be configured to execute instructions stored in memories 622, 632 respectively in order to perform various functions, such as processing of sensor data from the sensor system 205. Those instructions are illustrated in FIG. 6 as airborne aircraft encounters logic 510 and ground and airborne obstacles encounters logic 520, which logic may be implemented in hardware, software, firmware, or any combination thereof. In FIG. 6, airborne aircraft encounters logic 510 and ground and airborne obstacles encounters logic 520 are implemented in software and stored in respective memories for execution by the respective processors. However, other configurations are possible in other embodiments. These depicted logics 510, 520 may variously represent one or more algorithms, computational models, decision making rules or instructions, or the like implemented as software code or computer-executable instructions (i.e., routines, programs, objects, components, data structures, etc.) that, when executed by one or more processors, program the processor(s) to perform the particular functions of their respective logic. These modules are depicted in FIG. 6 as individual discrete components, each labelled as an individual “logic”, however, in various embodiments, the functions of each respective logic may be executable on their own or as part of one or more other modules; that is, any configuration of the depicted logical components may be used, whether implemented by hardware, software, firmware, or any combination thereof.

While the term “database” or “repository” is used herein, such structures variously may be, e.g., a cache, database, other data structure or any suitable type of repository. Memories 622, 632 may be any suitable storage medium, either volatile and non-volatile (e.g., RAM, ROM, EPROM, EEPROM, SRAM, flash memory, disks or optical storage, magnetic storage, or any other tangible or non-transitory medium), that stores information that is accessible by a processor 624, 634. While FIG. 6 illustrates two discrete memories, the embodiments described herein are not limited to any particular arrangement and other embodiments may store information in one combined memory, or with information stored in a different configuration in one or more memories, some local to the other components illustrated in FIG. 6 and/or some shared with, or geographically located near, other computing systems. In some instances, memories 622, 632 may be safety-of-life certified, though other configurations are possible in other embodiments.

It will be apparent that in the embodiment of FIG. 6, airborne aircraft encounters logic 510 and ground and airborne obstacles encounters logic 520 are arranged on different hardware from each other. Alternatively, airborne aircraft encounters logic 510 and ground and airborne obstacles encounters logic 520 may share hardware but be arranged to be logically independent from each other. In some alternative embodiments, the code of the logics 510, 520 may include position-independent code, or may be stored in different sections of a memory.

Note that the detect and avoid logic 210 or components thereof, when implemented in software, can be stored and transported on any computer-readable medium for use by or in connection with an instruction execution apparatus that can fetch and execute instructions. In the context of this document, a “computer-readable medium” can be any means that can contain or store code for use by or in connection with the instruction execution apparatus.

The foregoing is merely illustrative of the principles of this disclosure and various modifications may be made by those skilled in the art without departing from the scope of this disclosure. The above described embodiments are presented for purposes of illustration and not of limitation. The present disclosure also can take many forms other than those explicitly described herein. Accordingly, it is emphasized that this disclosure is not limited to the explicitly disclosed methods, systems, and apparatuses, but is intended to include variations to and modifications thereof, which are within the spirit of the following claims.

As a further example, variations of apparatus or process parameters (e.g., dimensions, configurations, components, process step order, etc.) may be made to further optimize the provided structures, devices and methods, as shown and described herein. In any event, the structures and devices, as well as the associated methods, described herein have many applications. Therefore, the disclosed subject matter should not be limited to any single embodiment described herein, but rather should be construed in breadth and scope in accordance with the appended claims.

What is claimed is:

1. A monitoring system for an aircraft, the monitoring system comprising:
a plurality of sensors for sensing data regarding one or more objects external to the aircraft;
an avoidance system comprising a first logic for generating a first recommendation for avoiding at least one of the one or more objects external to the aircraft and a second logic for generating a second recommendation for avoiding at least one of the one or more objects external to the aircraft; and
a controller configured to control a direction of the aircraft based on a generated recommendation,
wherein the first logic includes instructions for (a) receiving data indicative of an object sensed by the plurality of sensors, (b) generating the first recommendation based on the data indicative of the sensed object, and (c) transmitting, to the second logic, restriction data based on a position of the sensed object, and
wherein the second logic includes instructions for (i) receiving data indicative of an object sensed by the plurality of sensors, and (ii) in the case that the sensed object indicated by the received data is an aircraft, generating the second recommendation based on the data indicative of the sensed object and the restriction data.

2. The monitoring system of claim 1, wherein, if the second logic generates the second recommendation, the controller controls the direction of the aircraft based on the second recommendation, and
wherein, if the second logic does not generate the second recommendation, the controller controls the direction of the aircraft based on the first recommendation.

3. The monitoring system of claim 1, wherein the first logic receives data indicative of a non-aircraft object sensed by the plurality of sensors, and
wherein the second logic receives data indicative of aircraft sensed by the plurality of sensors.

4. The monitoring system of claim 1, wherein the aircraft is self-piloted.

5. The monitoring system of claim 1, wherein the first logic and the second logic operate in parallel.

6. The monitoring system of claim 1, wherein the avoidance system includes a first set of one or more processors configured to implement the first logic and a second set of one or more processors configured to implement the second logic.

7. The monitoring system of claim 1, further comprising:
a sensing system comprising a first machine learning logic for processing the data sensed by the plurality of sensors and generating a first detection result, a second machine learning logic for processing the data sensed by the plurality of sensors and generating a second detection result, and a validation logic for determining whether the difference between the first detection result and the second detection result is within an error bound,
wherein the first detection result and the second detection result respectively comprise data indicative of an object sensed by the plurality of sensors, and
wherein the sensing system transmits at least one of the first detection and the second detection result to the avoidance system.

8. The monitoring system of claim 7, wherein the first detection result further comprises data classifying the object sensed by the plurality of sensors.

9. The monitoring system of claim 1, wherein the first logic further includes instructions for receiving data indicative of one or more conditions external to the aircraft, and for generating the first recommendation based on the data indicative of the sensed object and on the data indicative of the one or more conditions external to the aircraft.

10. The monitoring system of claim 1, wherein the avoidance system further comprises a third logic, the third logic containing instructions for selecting between the first recommendation generated by the first logic and the second recommendation generated by the second logic and for transmitting, to the controller, the selected recommendation.

11. The monitoring system of claim 1, wherein the avoidance system further comprises a third logic, the third logic containing instructions for determining whether the second logic generated the second recommendation generated by and for, in a case that the second logic did not generate the second recommendation, transmitting, to the controller, the first recommendation.

12. The monitoring system of claim 1, wherein the avoidance system further comprises at least one element configured to determine an escape path for the aircraft based on one of the first recommendation and the second recommendation.

13. A monitoring system for an aircraft, the monitoring system comprising:
a controller configured to control a direction of the aircraft based on a generated recommendation;
at least one memory storing first avoidance instructions and second avoidance instructions, and
at least one processor coupled to the memory, the at least one processor being configured to execute the first avoidance instructions to perform steps comprising:
(a) receiving data indicative of a position of a first object external to the aircraft sensed by a plurality of sensors, wherein the first object is determined not to be an aircraft,
(b) generating a first recommendation to control the aircraft based on the position of the first object, and
(c) generating restriction data based on the position of the first object,
wherein the at least one processor is further configured to execute the second avoidance instructions to perform steps comprising:
i) receiving data indicative of a position of a second object external to the aircraft sensed by a plurality of sensors, wherein the second object is determined to be an aircraft, and
(ii) generating a second recommendation to control the aircraft based on the position of the second object and the restriction data, and
wherein the controller is configured to control the direction of the aircraft based on one of the first recommendation or the second recommendation.

14. The monitoring system of claim 13, wherein the aircraft is self-piloted.

15. The monitoring system of claim 13, wherein the first avoidance instructions and the second avoidance instructions are executed in parallel.

16. The monitoring system of claim 13, wherein the at least one processor is further configured to execute instructions stored in the at least one memory to perform steps comprising:
processing data sensed by a plurality of sensors;
executing a first machine learning logic for generating a first detection result based on the processed data,
executing a second machine learning logic for generating a second detection result based on the processed data, and
determining whether the difference between the first detection result and the second detection result is within an error bound.

17. The monitoring system of claim 13, wherein the at least one processor is further configured to execute the first avoidance instructions to perform steps comprising:
receiving data indicative of one or more conditions external to the aircraft, and
generating the first recommendation based on the position of the first object and on the data indicative of the one or more conditions external to the aircraft.

18. The monitoring system of claim 13, wherein the at least one processor is further configured to execute instructions stored in the at least one memory to perform steps comprising:
selecting between the first recommendation and the second recommendation, and
transmitting, to the controller, the selected recommendation.

19. The monitoring system of claim 13, wherein the at least one processor is further configured to execute instructions stored in the at least one memory to perform steps comprising:
determining an escape path for the aircraft based on one of the first recommendation and the second recommendation.

20. A method for controlling an aircraft to avoid one or more objects external to the aircraft, the method comprising:
receiving data indicative of a position of a first object external to the aircraft sensed by a plurality of sensors, wherein the first object is determined not to be an aircraft,
receiving data indicative of a position of a second object external to the aircraft sensed by a plurality of sensors, wherein the second object is determined to be an aircraft,
generating a first recommendation to control the aircraft based on the position of the first object,
generating restriction data based on a position of the first object,
generating a first recommendation to control the aircraft based on the position of the second object and the restriction data, and
controlling a direction of the aircraft based on one of the first recommendation or the second recommendation.
